(19) United States
(12) Patent Application Publication
(10) Pub. No.: US 2024/0029478 A1
(43) Pub. Date: Jan. 25, 2024

(54) DISTRIBUTION CONTROL APPARATUS, DISTRIBUTION MEDIATION SERVER, AND DISTRIBUTION MEDIATION METHOD

(71) Applicant: Mitsubishi Electric Corporation, Tokyo (JP)

(72) Inventors: Mitsuo SHIMOTANI, Tokyo (JP); Yoshinori UENO, Tokyo (JP); Yusuke ARAI, Tokyo (JP); Kunio FUNAKAWA, Tokyo (JP)

(73) Assignee: Mitsubishi Electric Corporation, Tokyo (JP)

(21) Appl. No.: 18/032,408

(22) PCT Filed: Jan. 21, 2021
(86) PCT No.: PCT/JP2021/001941

§ 371 Date: Apr. 18, 2023

(51) Int. Cl. G07C 5/00; G07C 5/08; G06Q 50/30

(52) U.S. Cl. CPC G07C 5/008; G07C 5/0808; G06Q 50/30

(57) ABSTRACT

A technique provided increases the possibility that a distribution destination is able to receive running-state information from a distribution source. A distribution control apparatus includes an acquisition unit that acquires the position of a vehicle included in the distribution source and running-state information including video information on the periphery of the vehicle, and a controller that performs control to distribute the running-state information from the distribution source to the distribution destination that has permitted distribution of the running-state information in advance, when the vehicle is determined to be positioned within a range corresponding to a set path that is preset by the distribution source, based on the position of the vehicle and the set path.

### TECHNICAL FIELD

The present disclosure relates to a distribution control apparatus, a distribution control method, a distribution mediation server, and a distribution mediation method.

### BACKGROUND ART

For example, Patent Document 1 proposes information providing services for distributing video captured by a running vehicle or any other information to a client when position information on the vehicle satisfies position information that is set b the client. This configuration enables the client who is the distribution destination of information to experience a virtual feeling of driving the vehicle at a position set by the client.

### PRIOR ART DOCUMENT

### Patent Document

Patent Document 1: Japanese Patent Application Laid-Open No. 2019-032725

### SUMMARY

### Problem to be Solved by the Invention

However, whether the running vehicle passes a position that is set by the client and indicated by the position information depends on coincidence. Thus, a problem arises in which there is a low possibility that a distribution destination such as a client is able to receive information from a distribution source such as a vehicle.

The present disclosure has been made in light of the problem as described above, and it is an object of the present disclosure to provide a technique capable of increasing the possibility that the distribution destination is able to receive running-state information from the distribution source

### MEANS TO SOLVE THE PROBLEM

A distribution control apparatus includes an acquisition unit that acquires a position of a vehicle included in a distribution source and running-state information that includes video information on a periphery of the vehicle, and a controller that performs control to distribute the running-state information from the distribution source to a distribution destination that has permitted distribution of the running-state information in advance, when the vehicle is determined to be positioned within a range corresponding to a set path that is preset by the distribution source, based on the position of the vehicle and the set path.

### Effects of the Invention

According to the present disclosure, when the vehicle is determined to be positioned within the range corresponding to a set path that is preset by the distribution source, based on the position of the vehicle and the set path, the distribution control apparatus performs control to distribute the running-state information from the distribution source to the distribution destination that has permitted the distribution of the running-state information in advance. This configuration increases the possibility that the distribution destination is able to receive the running-state information from the distribution source.

These and other objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a block diagram illustrating a configuration of a distribution control device according to Embodiment 1.

FIG. 2 is a flowchart illustrating operations of the distribution control device according to Embodiment 1.

FIG. 3 is a block diagram illustrating a configuration of a distribution control device according to Variation 4 of Embodiment 1.

FIG. 4 shows an example of display on a live-information reproducer according to Variation 4 of Embodiment 1.

FIG. 5 is a block diagram illustrating a configuration of a distribution mediation server according to Embodiment 2.

FIG. 6 is a flowchart illustrating operations of the distribution mediation server according to Embodiment 2.

FIG. 7 is a diagram showing one example of invitation conditions according to Embodiment 2.

FIG. 8 is a flowchart mainly illustrating operations of the distribution mediation server according to Embodiment 2.

FIG. 9 shows an example of display on a trip-participation communication terminal according to Embodiment 2.

FIG. 10 shows an example of display on the trip-participation communication terminal according to Embodiment 2.

FIG. 11 shows an example of display on the trip-participation communication terminal according to Embodiment 2.

FIG. 12 is a block diagram illustrating a configuration of a distribution mediation server according to Embodiment 3.

FIG. 13 is a flowchart illustrating operations of the distribution mediation server according to Embodiment 3.

FIG. 14 is a flowchart mainly illustrating operations of the distribution mediation server according to Embodiment 3.

FIG. 15 is a block diagram illustrating a configuration of a distribution mediation server according to Embodiment 4.

FIG. 16 is a block diagram illustrating a hardware configuration of a distribution control device according to another variation.

FIG. 17 is a block diagram illustrating a hardware configuration of a distribution control device according to another variation.

### DESCRIPTION OF EMBODIMENTS

### Embodiment 1

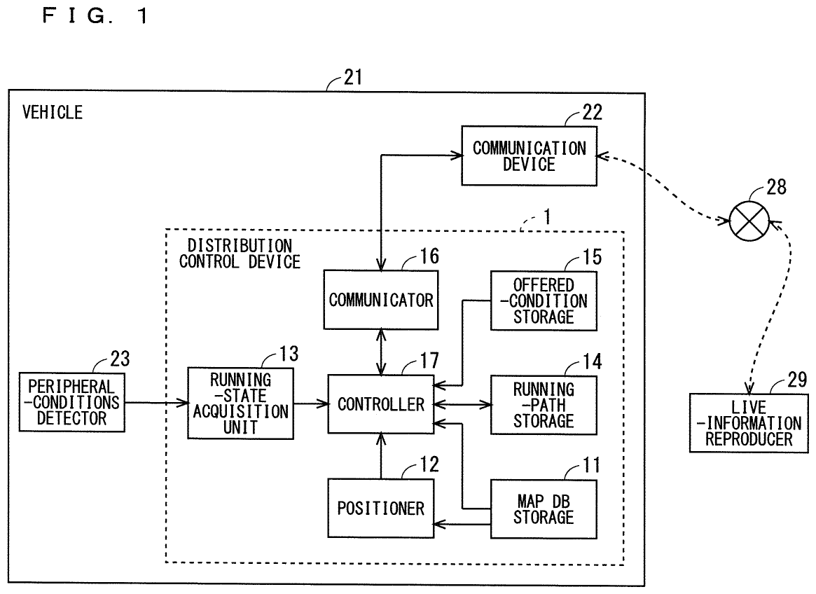

FIG. 1 is a block diagram illustrating a configuration of a distribution control device 1 according to Embodiment 1 of the present disclosure. The distribution control device 1 in FIG. 1 is provided in a vehicle 21 included in a distribution source. The distribution source may be only the vehicle 21, or may include the vehicle 21 and a distribution management device capable of communication with the vehicle 21.

The distribution control device 1 in FIG. 1 is communicably connected to a communication device 22 and a peripheral-condition detector 23 that are provided in the vehicle 21. Although the distribution control device 1 in FIG. 1 does not include either the communication device 22 or the peripheral-condition detector 23, the distribution control device 1 may include the communication device 22 and the peripheral-condition detector 23.

The distribution control device 1, the communication device 22, and the peripheral-condition detector 23 configure an information distribution device that distributes running-state information to a distribution destination, the running-state information including video information on the periphery of the vehicle 21 obtained by the vehicle 21. The distribution destination may be only a live-information reproducer 29 of a client, or may include the live-information reproducer 29 and a terminal capable of communication with the live-information reproducer 29. The live-information reproducer 29 is a device that reproduces the running-state information distributed from the distribution control device 1 and, for example, may reproduce the video information included in the running-state information so as to enable display of the video information.

The communication device 22 is configured to be capable of communication with the outside of the vehicle 21 such as a communication network 28. The distribution control device 1 performs control so as to distribute the running-state information on the vehicle 21 from the communication device 22 via the communication network 28 to the distribution destination. In the following description, for example, the communication of the distribution control device 1 with the distribution destination via the communication device 22 and the communication network 28 may be abbreviated as, for example, the communication of the distribution control device 1 with the distribution destination, with the communication device 22 and the communication network 28 being omitted from the description.

The peripheral-condition detector 23 detects information that serves as a basis for the running-state information. One example of the peripheral-condition detector 23 may be an image capturing device that captures video information on the front of the vehicle 21 as the video information included in the running-state information.

Distribution Control Device

The distribution control device 1 in FIG. 1 includes a map database (DB) storage 11, a positioner 12, a running-state acquisition unit 13, a running-path storage 14, a offered-condition storage 15, a communicator 16, and a controller 17. The positioner 12 and the running-state acquisition unit 13 are included in the concept of an acquisition unit. The map DB storage 11, the running-path storage 14, and the offered-condition storage 15 as a whole may be implemented as a single storage device, or may be implemented as a plurality of storage devices.

The map DB storage 11 stores a map DB that may include, for example, road map information. For example, the map DB may be a national-level map DB used in path finding, path guidance, road display, or map matching.

The positioner 12 acquires the position of the vehicle 21. Examples of the positioner 12 include a global navigation satellite system (GNSS) receiver, sensors of the vehicle 21, and interfaces for these devices. The positioner 12 may perform map matching on the acquired position of the vehicle 21 based on the map DB stored in the map DB storage 11.

The running-state acquisition unit 13 generates and acquires the running-state information based on the information detected by the peripheral-condition detector 23.

The running-path storage 14 stores invitation conditions that include a set path and a set date and time that are preset by the distribution source, as conditions for distributing the running-state information. For example, the distribution source may preset the set path based on the path contained in the map DB stored in the map DB storage 11. Hereinafter, the invitation conditions stored in the running-path storage 14 may also be referred to as “trip invitation conditions.”

The offered-condition storage 15 stores those of the trip invitation conditions that are offered to a candidate for the distribution destination and under which the candidate for the distribution destination permits the distribution of the running-state information. The permission by the candidate for the distribution destination as used herein may also be referred to as agreement or approval by the candidate for the distribution destination and may be made by, for example, an operation performed on the live-information reproducer 29 by a candidate for the client. The candidate for the distribution destination that has permitted the distribution becomes a distribution destination to which the running-state information is distributed from the vehicle 21. In Embodiment 1 of the present disclosure, the offered-condition storage 15 stores not only the trip invitation conditions under which the candidate for the distribution destination permits the distribution of the running-state information, but also authentication information on the candidate for the distribution destination that has permitted the distribution, as authentication information on the distribution destination.

The communicator 16 controls the communication device 22 under the control of the controller 17. For example, the communication or the like of the controller 17 with the distribution destination via the communicator 16 and via the communication device 22 and the communication network 28 may be hereinafter abbreviated as the communication or the like of the controller 17 with the distribution destination, with the communicator 16, communication device 22, and the communication network 28 being omitted from the description.

The controller 17 transmits and offers the trip invitation conditions stored in the running-path storage 14 to the candidate for the distribution destination. When the candidate for the distribution destination permits the distribution of the running-state information under the offered trip invitation conditions, the controller 17 stores the trip invitation conditions under which the distribution is permitted, and the authentication information on the distribution destination in the offered-condition storage 15.

The controller 17 determines whether the vehicle 21 is positioned within a path range that is a range corresponding to the set path, on the basis of the position of the vehicle 21 acquired by the positioner 12 and the set path included in the trip invitation conditions stored in the offered-condition storage 15. For example, the path range may be the range of the set path itself stored in the map DB, or may be a range that is within a fixed distance from the set path, or may be a range of one or a plurality of portions of the set path.

When the vehicle 21 is determined to be positioned within the path range, the controller 17 performs control so as to distribute the running-state information from the distribution source such as the vehicle 21 to the distribution destination such as the live-information reproducer 29 that permits in advance the distribution of the running-state information regarding the set path.

Operations

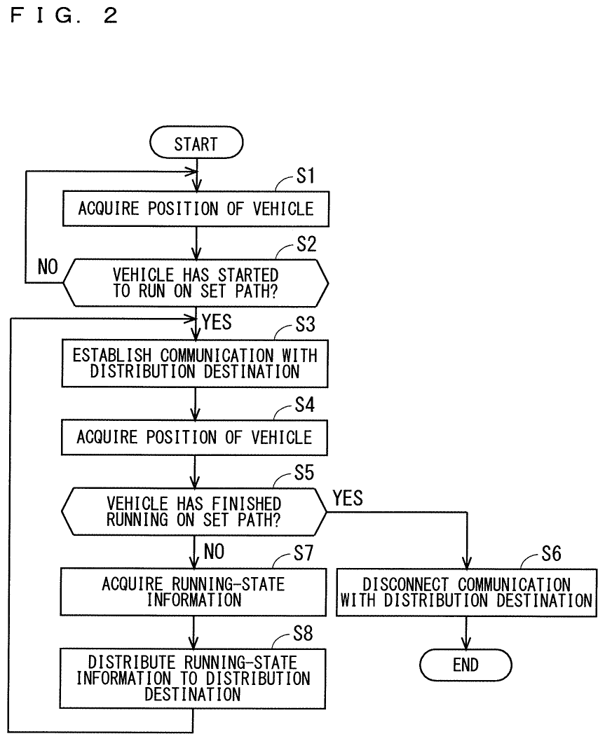

FIG. 2 is a flowchart illustrating operations of the distribution control device 1 according to Embodiment 1 of the present disclosure. It is assumed that the offer of the trip invitation conditions and the permission to distribute the running-state information have already been given before execution of the operations in FIG. 2.

First, in step S1, the positioner 12 acquires the position of the vehicle 21.

In step S2, the controller 17 determines whether the vehicle 21 has moved from the outside of the path range to the inside of the path range, on the basis of the position of the vehicle 21 acquired by the positioner 12 and the set path included in the trip invitation conditions stored in the offered-condition storage 15. That is, the controller 17 determines whether the vehicle 21 has started to run on the set path. When the vehicle 21 is determined to have started to run on the set path, the processing proceeds to step S3, and when the vehicle 21 is determined not yet to start to run on the set path, the processing returns to step S1.

In step S3, the controller 17 establishes communication between the communication device 22 and the distribution destination based on the authentication information stored in the offered-condition storage 15. When the controller 17 has failed to establish the communication as a result of a fixed number of authentication failures in authentication processing based on the authentication information, the controller 17 may, for example, stop the operations in FIG. 2 and perform error processing such as notifying an exterior such as a third party of the fact that the authentication has failed.

To establish the communication between the communication device 22 and the distribution destination, a secret communication method such as virtual private network (VPN) connection or any other method may be used. As a distribution tool, for example, existing systems for TV conferences such as Skype (registered trademark) or Microsoft Teams (registered trademark) by Microsoft Corporation may be used.

In step S4, the positioner 12 acquires the position of the vehicle 21.

In step S5, whether the vehicle 21 has moved from the inside of the path range to the outside of the path range is determined on the basis of the position of the vehicle 21 acquired by the positioner 12 and the set path included in the trip invitation conditions stored in the offered-condition storage 15. That is, the controller 17 determines whether the vehicle 21 has finished running on the set path. When the vehicle 21 is determined to have finished running on the set path, the processing proceeds to step S6, and when the vehicle 21 is determined not yet to start to run on the set path, the processing proceeds to step S7.

In step S6, the controller 17 performs processing for finishing the distribution of the running-state information by, for example, disconnecting the communication between the communication device 22 and the distribution destination. Thereafter, the operations in FIG. 2 end.

In step S7, the running-state acquisition unit 13 acquires the running-state information.

In step S8, the controller 17 distributes the running-state information acquired by the running-state acquisition unit 13 to the distribution destination, and the live-information reproducer 29 of the distribution destination reproduces the distributed running-state information. Note that the distribution of the running-state information may be live distribution, or may be distribution that is substantially the same as live distribution. Thereafter, the processing returns to step S4.

Summary of Embodiment 1

The distribution control device 1 according to Embodiment 1 of the present disclosure as described above performs control such that, when the vehicle 21 is determined to be positioned within the range corresponding to the set path that is preset by the distribution source, the running-state information is distributed from the distribution source such as the vehicle 21 to the distribution destination that has permitted the distribution in advance. According to this configuration, since the set path for which the running-state information is distributed is preset by the distribution source, it is possible to increase the possibility that the distribution destination such as a client is able to receive the running-state information from the distribution source such as the vehicle 21. It is also possible to satisfy the desire of a user on the distribution source side to share driving conditions with someone or the desire of a client to share driving conditions that are planned by someone.

Variation 1 of Embodiment 1

In Embodiment 1, as in the processing performed in step S3 in FIG. 2, the distribution control device 1 serving as the distribution source makes access to the distribution destination so as to establish the communication between the distribution source and the distribution destination. However, the method and procedure for establishing the communication between the distribution control device 1 and the distribution destination are not limited to those described above, and may be any method or procedure as long as the communication is ultimately established. For example, the distribution destination may make access to the distribution control device 1 serving as the distribution source to establish the communication between the distribution source and the distribution destination. In this case, after the communication between the distribution source and the distribution destination is established, the controller 17 may distribute the running-state information to the distribution destination when the vehicle 21 starts to run on the set path. As another alternative, irrespective of the method and procedure for establishing the communication between the distribution control device 1 and the distribution destination, the controller 17 may transmit the position of the vehicle 21 to the distribution destination from after the communication between the distribution source and the distribution destination is established until when the vehicle 21 starts to run on the set path.

Variation 2 of Embodiment 1

The communication device 22 may receive traffic information on the vehicle 21. Then, the controller 17 may determine, on the basis of the position of the vehicle 21 and the traffic information that are received by the communication device 22, whether a predicted start time at which the vehicle 21 is predicted to start to run on the set path becomes before or after the set date and time. Then, when the predicted start time is determined to become before or after the set date and time, the controller 17 may transmit the position of the vehicle 21 and the predicted start time in advance to the distribution destination. Alternatively, when the vehicle 21 becomes incapable of running on the set path due to reasons such as accidents, disasters, or personal reasons, the controller 17 may transmit the conditions and the reasons in advance to the distribution destination.

Variation 3 of Embodiment 1

Although, in Embodiment 1, the distribution control device 1 provided in the vehicle 21 directly communicates with the distribution destination, the present disclosure is not limited to this example. For example, the distribution control device 1 provided in the vehicle 21 may distribute the running-state information via a distribution server to the distribution destination. As another alternative, the distribution control device 1 may be provided in the distribution server, instead of being provided in the vehicle 21.

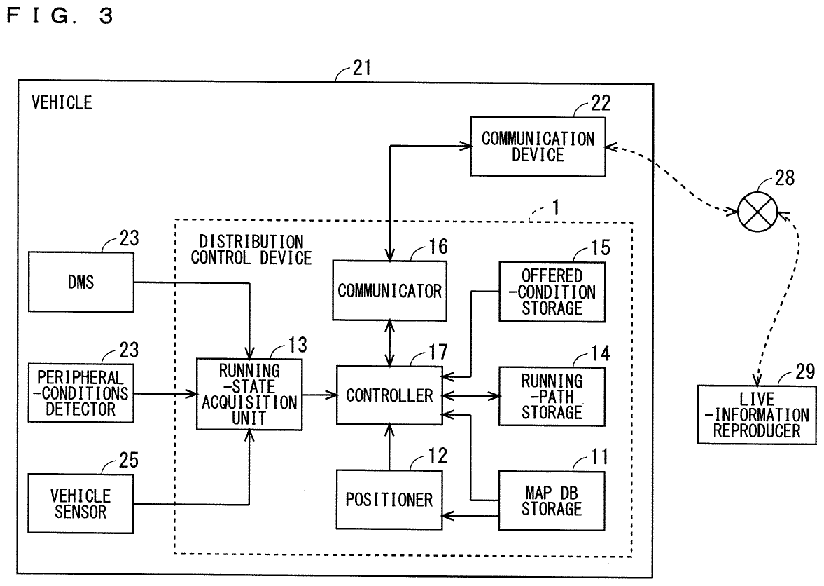

Variation 4 of Embodiment 1 FIG. 3 is a block diagram illustrating a configuration of the distribution control device 1 according to Variation 4 of the present disclosure. In Variation 4 of the present disclosure, the running-state information includes information different from the video information obtained by the image capturing device. For example, in the case where the peripheral-condition detector 23 includes a light detection and ranging (LiDAR), a millimeter wave radar, an ultrasound sensor, an electron mirror image capturing device, and a microphone, the running-state information may further include information detected by these sensors as detection information detected by the vehicle 21. That is, the running-state information may further include, as the detection information, distance information and object information that are detected by the LiDAR, the millimeter wave radar, and the ultrasound sensor, video information on the rearward sides of the vehicle 21 detected by the electron mirror image capturing device, and audio information on the periphery of the vehicle acquired by the microphone.

The video information and the audio information included in the running-state information may be capable of three-dimensional reproduction. That is, the video information may be video information capable of displaying three dimensional video, and the audio information may be audio information capable of implementing stereophonic sound collected by a plurality of microphones.

The running-state information may further include information on the position of the vehicle 21 on a search path, and when the vehicle 21 is running on a road with a plurality of lanes, the running-state information may further include information that indicates a lane on which the vehicle 21 is running among the lanes.

In the configuration illustrated in FIG. 3, a vehicle sensor 25 and a driver monitoring system (DMS) 26 are provided in the vehicle 21.

The vehicle sensor 25 detects running sensor information displayed on the meter panel (also referred to as the meter cluster) of the vehicle 21, vehicle sensor information used to control travel of the vehicle 21, and weather information on the weather around the vehicle 21. Examples of the running sensor information include information such as the speed, the brake, the indicating lamp, the warning lamp, fuel, the temperature in the engine room, air bags, and shift positions of the vehicle 21. Examples of the vehicle sensor information include information such as vibrations, acceleration, pitch, yaw rate, roll, and inflation pressure. Examples of the weather information include information such as weather, temperature, humidity, illumination, and wind velocity.

The DMS 26 detects physiological information, mental information, and posture information on the driver of the vehicle 21. Examples of the physiological information include information such as the pulse of the driver. Examples of the mental information include information such as impression and boredom. Examples of the posture information include information such as the orientation of the face of the driver.

The running-state information may further include the running sensor information, the vehicle sensor information, and the weather information that are detected by the vehicle sensor 25, and the physiological information, the mental information, and the posture information on the driver, which are detected by the DMS 26. The running-state information may further include information such as operating-status information on the vehicle 21 and traffic information received by the vehicle 21.

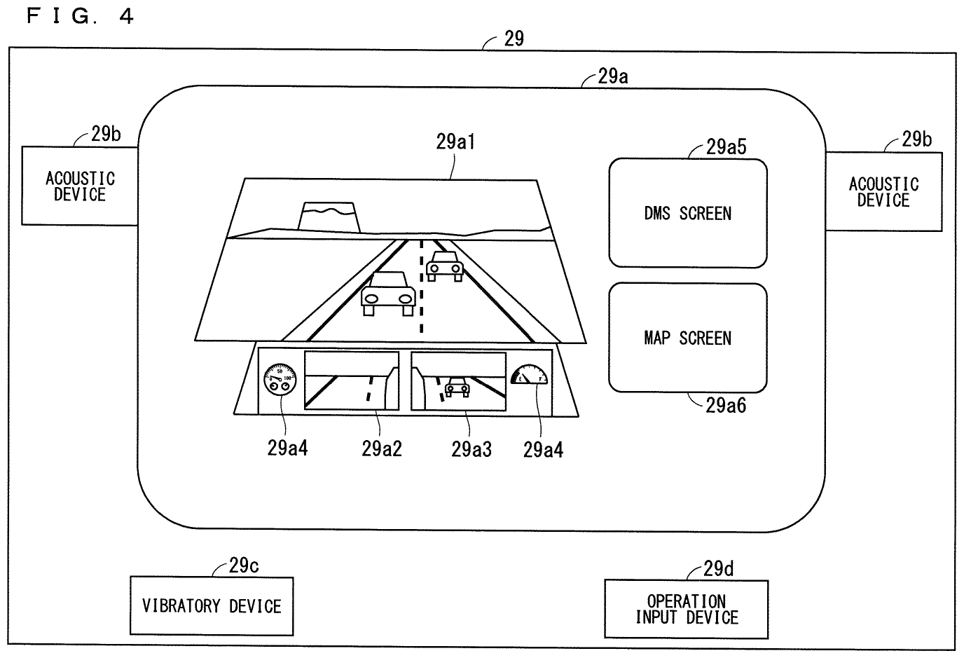

The live-information reproducer 29 reproduces the running-state information distributed from the distribution control device 1 so as to make the running-state information displayable, viewable, and perceivable. FIG. 4 shows an example of display of the running-state information on the live-information reproducer 29 according to Variation 4 of the present disclosure.

The live-information reproducer 29 includes a display device 29a, acoustic devices 29b, a vibratory device 29c, and an operation input device 29d.

The display device 29a displays video based on the running-state information. For example, the display device 29a may display video information such as video 29a1 showing the front of the vehicle 21 in a display object that simulates a windshield. The display device 29a also displays, in a display object that simulates the meter panel, video 29a2 showing the left rearward of the vehicle 21 and video 29a3 showing the right rearward of the vehicle 21 that are both detected by the electron mirror image capturing device, and meters 29a4 that indicate information such as the running sensor information, the vehicle sensor information, and the weather information.

The display device 29a shows the physiological information, the mental information, and the posture information on the driver on a DMS screen 29a5. The display of the mental information may use, for example, facial expressions of avatars. The display device 29a displays a map and the position of the vehicle 21 on a map screen 29a6. The display device 29a may further display other information such as traffic information on the map screen 29a6. In the case where the running-state information is information capable of displaying three-dimensional video, the display device 29a may display three-dimensional video based on the running-state information. The configuration as described above enhances a sense of realism during driving because measuring instruments or the like are displayed on the live-information reproducer 29 of the client.

The acoustic devices 29b provided on the right and left sides of the display device 29a output information such as audio information included in the running-state information. For example, the acoustic devices 29b may output the audio information via a stereo system or a 5.1 channel surround system.

The vibratory device 29c is a device that expresses, for example, vibrations and acceleration detected by the vehicle 21. For example, the vibratory device 29c may be a vibration generator built in a seat on which the client is seated, may be a vibration generator built in a device portable by the client, or may be a wearable device.

The operation input device 29d acquires various requests such as operations or commands from the client. The requests acquired by the operation input device 29d are appropriately transmitted to the distribution source including the vehicle 21.

Note that the live-information reproducer 29 may, for example, be a remote manipulator dedicated for the vehicle 21, may be a general-purpose device such as a TV device, a personal computer, or a smartphone, or may be a device that reproduces a virtual space.

Note that the distribution control device 1 may adjust the display rate (corresponding to the resolution) at which the information is distributed to the live-information reproducer 29, depending on the communication generation of the live-information reproducer 29. For example, in the case where the communication generation of the live-information reproducer 29 is 5G, the distribution control device 1 may distribute the video information showing the front, rear, right, and left sides of the vehicle 21 at an as-is display rate without being processed. For example, in the case where the communication generation of the live-information reproducer 29 is 4G, the distribution control device 1 may distribute video information showing the front of the vehicle 21 at an as-is display rate without being processed, and may distribute video information showing the other directions of the vehicle 21 at a one-fourth display rate.

Variation 5 of Embodiment 1

During a distribution period in which the running-state information is distributed while the vehicle 21 is running on the set path, the distribution source including the vehicle 21 and the distribution destination of the client may interactively exchange information. For example, in the case where a request is transmitted from the distribution destination to the vehicle 21 and this request is executed on the side of the vehicle 21 during the distribution period, the controller 17 may store the request transmitted from the distribution destination and executed on the side of the vehicle 21 in a storage such as the offered-condition storage 15.

The request transmitted from the distribution destination to the vehicle 21 may be a request that is transmitted from the distribution destination to the driver of the vehicle 21 via at least either one of audio and display of characters and graphics. In this case, the driver of the vehicle 21 may replay to accept the request via any of an operations, audio, and gestures. The request transmitted from the distribution destination via audio and the replay to the request from the driver may, for example, be conversation between the driver and the client by means of microphones and speakers.

The request transmitted from the distribution destination to the vehicle 21 may also be a request for driving of the vehicle 21, such as a request to change the lane of the vehicle 21, a request to change the speed of the vehicle 21, and a request to change the set path. Examples of the request to change the set path include “temporarily park the vehicle and show the scenery” and “take a detour.”

The request transmitted from the distribution destination to the vehicle 21 may also be a request to change settings of a vehicle device provided in the vehicle 21. Examples of the settings of the vehicle device include settings of the imaging direction of the image capturing device included in the peripheral-condition detector 23, and settings of the scaling of the video. As another alternative, temporary control of the vehicle device may be given to the distribution destination so as to allow the vehicle device to automatically change the settings of the vehicle device in response to a request transmitted from the distribution destination. As yet another alternative, the settings of the vehicle device may be changed by the driver of the vehicle 21 operating the vehicle device in response to a request from the distribution destination.

Variation 6 of Embodiment 1

The controller 17 may operate in cooperation with a money receiving device provided in the vehicle 21. The money receiving device calculates a distribution fee that is to be paid to the distribution source, based on compensation conditions and a history of the running-state information distributed from the vehicle 21 to the distribution destination. Examples of the compensation conditions include the set path, the type of the distribution information, the offer of personal information such as an image of the face of the driver, and the presence or absence of a request from the distribution destination to the distribution source during the distribution period. The money receiving device may reduce the distribution fee when the vehicle 21 has stopped running and when the vehicle 21 has failed to distribute the running-state information at the set date and time. In the case where a server that serves to mediate between the distribution source and the distribution destination is configured to accumulate a history of the compensation conditions, the money receiving device may calculate the distribution fee, using the history of the compensation conditions accumulated in the server. Note that this money receiving device is substantially the same as a charging device, which will be described later in Embodiment 4.

Variation 7 of Embodiment 1

The distribution control device 1 may be provided in a drive recorder that has a communication function and that is capable of recording video and sound of the vehicle 21. In this case, the distribution control device 1 can also use the function of the drive recorder. This reduces the cost of the distribution control device 1.

### Embodiment 2

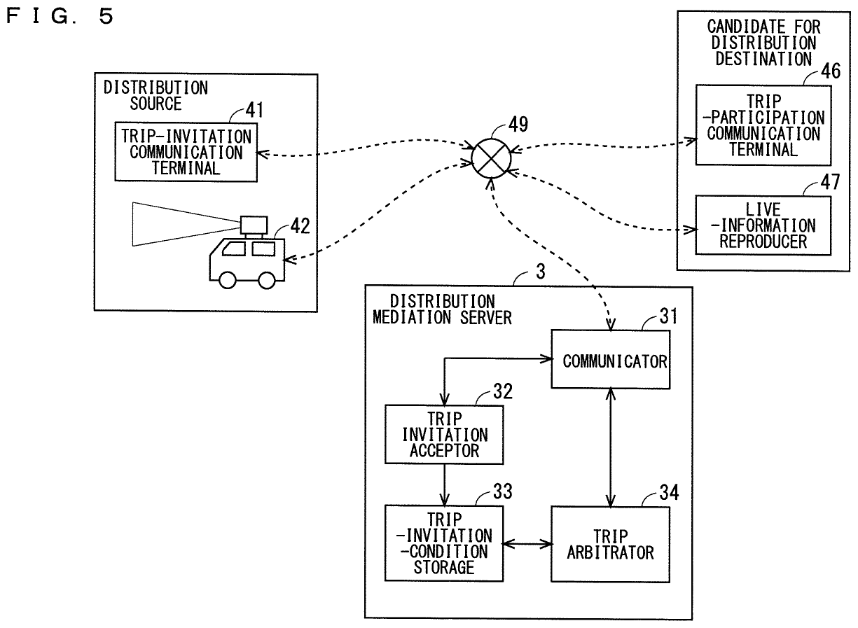

FIG. 5 is a block diagram illustrating a configuration of a distribution mediation server 3 according to Embodiment 2 of the present disclosure. Although, in Embodiment 1, the vehicle 21 serving as the distribution source receives permission for distribution from the candidate for the distribution destination, in Embodiment 2 of the present disclosure, the distribution mediation server 3 mediates a distribution contract between the distribution source and the candidate for the distribution destination, and the distribution source receives permission for distribution via the distribution mediation server 3 from the candidate for the distribution destination.

Distribution Source

In Embodiment 2 of the present disclosure, the distribution source includes a trip-invitation communication terminal 41 and a running-state distribution vehicle 42.

The trip-invitation communication terminal 41 transmits invitation conditions to the distribution mediation server 3 via a communication network 49. The invitation conditions are conditions that are preset as conditions for distribution of the running-state information by the distribution source and that include a set path and a set date and time.

The running-state distribution vehicle 42 is substantially the same as the distribution control device 1 and the vehicle 21 described in Embodiment 1, and distributes the running-state information to the distribution destination via the communication network 49 when it is positioned within a range corresponding to the set path. In Embodiment 2 of the present disclosure, the running-state distribution vehicle 42 receives invitation conditions from the distribution mediation server 3 when these invitation conditions are permitted by the candidate for the distribution destination. The trip-invitation communication terminal 41 may be provided in the running-state distribution vehicle 42, may be provided in a distribution control device that is similar to the one described in Embodiment 1 and that is provided in the running-state distribution vehicle 42, or may be a device such as a personal computer or a smartphone outside the running-state distribution vehicle 42.

Candidate for Distribution Destination

In Embodiment 2 of the present disclosure, the candidate for the distribution destination includes a trip-participation communication terminal 46 and a live-information reproducer 47.

The distribution mediation server 3 transmits and offers invitation conditions to the trip-participation communication terminal 46 via the communication network 49. The trip-participation communication terminal 46 permits the distribution of the invitation conditions offered from the distribution source via the distribution mediation server 3. This permission is made based on, for example, operations made on the trip-participation communication terminal 46 by a candidate for the client. When having permitted the distribution, the candidate for the distribution destination becomes the distribution destination to which the running-state information is distributed from the running-state distribution vehicle 42. Note that the permission to distribute the running-state information corresponds to an application for distribution of the running-state information and an application for participation in a trip.

The live-information reproducer 47 is substantially the same as the live-information reproducer 29 described in Embodiment 1 and reproduces the running-state information distributed from the running-state distribution vehicle 42. In Embodiment 2 of the present disclosure, information on the trip-participation communication terminal 46 is transferred to the live-information reproducer 47. Note that the trip-participation communication terminal 46 and the live-information reproducer 47 may be an integrated device, or may be individual devices. The trip-participation communication terminal 46 and the live-information reproducer 47 each may be a general-purpose device such as a personal computer or a smartphone, or may be a dedicated device.

Distribution Mediation Server

The distribution mediation server 3 in FIG. 5 includes a communicator 31, a trip invitation acceptor 32, a trip-invitation-condition storage 33, and a trip arbitrator 34. The trip-invitation-condition storage 33 is included in the concept of a storage, and the trip arbitrator 34 is included in the concept of a controller.

The communicator 31 performs communication with the distribution source and the candidate for the distribution destination via the communication network 49.

The trip invitation acceptor 32 accepts invitation conditions received by the communicator 31 from the trip-invitation communication terminal 41.

The trip-invitation-condition storage 33 stores invitation conditions when the communicator 31 has received the invitation conditions from the distribution source and the trip invitation acceptor 32 has accepted the invitation conditions. In the case where the trip invitation acceptor 32 has accepted one or more invitation conditions from one or more trip-invitation communication terminals 41, the trip-invitation-condition storage 33 stores the one or more invitation conditions. Hereinafter, the invitation conditions stored in the trip-invitation-condition storage 33 may also be referred to as the “trip invitation conditions.”

The trip arbitrator 34 performs control so as to communicate with the distribution source and the candidate for the distribution destination via the communicator 31 and the communication network 49. Hereinafter, the communication or the like of the trip arbitrator 34 with the distribution source and the candidate for the distribution destination via the communicator 31 and the communication network 49 may also be abbreviated as the communication or the like of the trip arbitrator 34 with the distribution source and the candidate for the distribution destination, with the communicator 31 and the communication network 49 being omitted from the description.

In the case where the communicator 31 is accessed from the candidate for the distribution destination such as the trip-participation communication terminal 46, the trip arbitrator 34 performs control so as to transmit the trip invitation conditions from the communicator 31 to the candidate for the distribution destination such as the trip-participation communication terminal 46. In the case where the communicator 31 has received permission to distribute the running-state information on trip invitation conditions from the candidate for the distribution destination such as the trip-participation communication terminal 46, the trip arbitrator 34 performs control so as to transmit distribution-destination establishment information from the communicator 31 to the distribution source such as the running-state distribution vehicle 42. Note that the distribution-destination establishment information is information for the distribution source such as the running-state distribution vehicle 42 to set the candidate for the distribution destination as the distribution destination of the running-state information.

Operations

The following description divides the operations of the distribution mediation server 3 according to Embodiment 2 of the present disclosure into a condition receiving operation of receiving and accumulating trip invitation conditions from the distribution source and a permission receiving operation of receiving permission to distribute the running-state information from the distribution destination. Note that the condition receiving operation and the permission receiving operation may be performed in parallel, or may be performed or in series. Moreover, the condition receiving operation and the permission receiving operation each may be a single task, or may be a multiple task including two or more tasks.

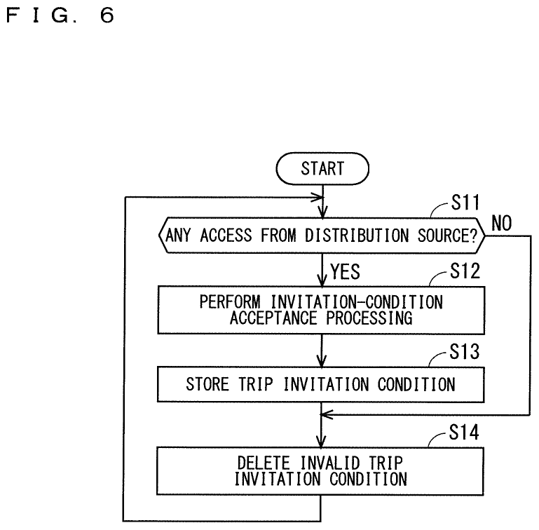

FIG. 6 is a flowchart illustrating the condition receiving operation of the distribution mediation server 3 according to Embodiment 2 of the present disclosure.

First, in step S11, the trip arbitrator 34 determines whether the communicator 31 has been accessed from the distribution source such as the trip-invitation communication terminal 41. When the communicator 31 is determined to have been accessed from the distribution source, the processing proceeds to step S12, and when the communicator 31 is determined not to have been accessed from the distribution source, the processing proceeds to step S14.

In step S12, the distribution mediation server 3 performs invitation-condition acceptance processing. Specifically, the trip arbitrator 34 performs control so as to display a menu image on the display screen of the distribution source. When having accepted a predetermined operation made on the display screen by a distributor, the distribution source transmits invitation conditions to the distribution mediation server 3. The communicator 31 receives the invitation conditions from the distribution source, and the trip invitation acceptor 32 accepts the invitation conditions received by the communicator 31.

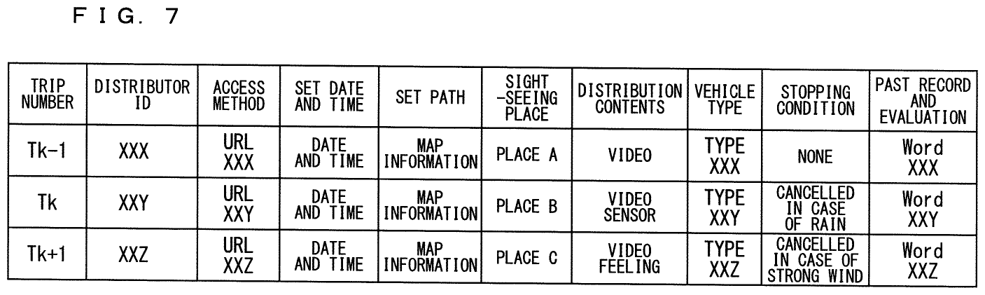

FIG. 7 shows one example of the invitation conditions according to Embodiment 2 of the present disclosure. The invitation conditions include the set path and the set date and time. In the example illustrated in FIG. 7, the invitation conditions further include the trip number, the distributor ID, an access method, a sight-seeing place, distribution contents, the vehicle type, stopping conditions, and past records and reputation, but it is not an absolute necessity for the invitation conditions to include all of them.

The trip number is the number assigned to each invitation condition by the distribution mediation server 3. The distributor ID is the ID of each distributor registered in the distribution mediation server 3 and, for example, associated with a distributor DB that stores information such as address, name, and age of the distributor. The access method refers to a method and an URL for allowing the distribution mediation server 3 to receive the running-state information from the running-state distribution vehicle 42.

The set date and time is the date and time when the running-state distribution vehicle 42 distributes the running-state information. The set path is the path associated with the map, and the running-state distribution vehicle 42 distributes the running-state information when running on at least part of the set path. The set path may have other information added thereto, such as the sight-seeing place and the time (or process) at which the running-state distribution vehicle 42 is scheduled to make a stop during driving.

The distribution contents correspond to the running-state information and includes the video information obtained by the running-state distribution vehicle 42. The distribution contents may include various other types of information described in Variation 4 of Embodiment 1, in addition to the video information. The vehicle type includes at least one of vehicle type, vehicle manufacturer's name, or model name of the running-state distribution vehicle 42. The stopping condition is the condition for stopping the travel of the running-state distribution vehicle 42 and may include weather, for example. The past records and reputation include records and reputation of the distributor such as information indicating whether past distribution from the distribution source has been completed property.

In step S13 in FIG. 6, the trip invitation acceptor 32 stores the accepted invitation conditions in the trip-invitation-condition storage 33. In this way, the trip invitation conditions are accumulated in the trip-invitation-condition storage 33. Although the description here is given of the processing for accepting and storing the invitation conditions in steps S12 and S13, other processing such as changing or deleting the invitation conditions may be performed additionally.

In step S14, the trip arbitrator 34 deletes invalid trip invitation conditions from the trip-invitation-condition storage 33. For example, the trip arbitrator 34 may delete trip invitation conditions whose set date and time have passed and the current date and time is later by a threshold value or more from the set date and time. As will be described later in Embodiment 3, the trip arbitrator 34 may delete trip invitation conditions depending on the reliability of a distribution contract for the distribution source. After step S14, the processing returns to step S11.

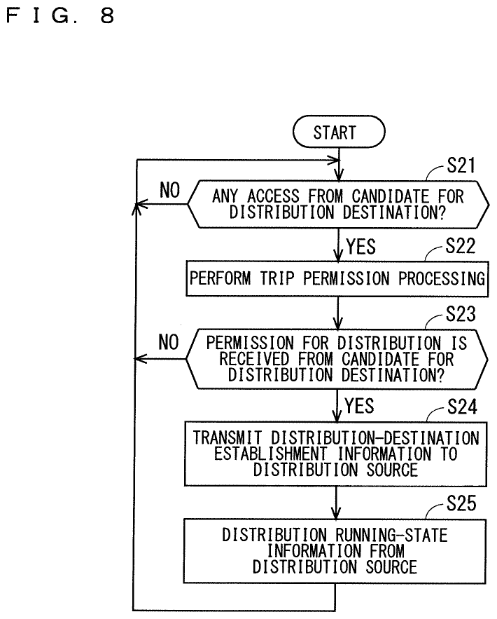

FIG. 8 is a flowchart mainly illustrating the permission receiving operation of the distribution mediation server 3 according to Embodiment 2 of the present disclosure.

First, in step S21, the trip arbitrator 34 determines whether the communicator 31 has been accessed from the candidate for the distribution destination such as the trip-participation communication terminal 46. When the communicator 31 is determined to have been accessed from the candidate for the distribution destination, the processing proceeds to step S22, and when the communicator 31 is determined not to have been accessed from the candidate for the distribution destination, the processing of step S21 is performed again.

In step S22, the distribution mediation server 3 performs trip permission processing. Specifically, the trip arbitrator 34 performs control so as to display an image for allowing selection of trip invitation conditions received from the distribution source, on the display screen of the candidate for the distribution destination such as the trip-participation communication terminal 46. The trip-participation communication terminal 46 may have the function of, upon accepting a condition request for a trip invitation condition from the user, receiving and offering a trip invitation condition that matches or nearly matches with the condition request received from the distribution mediation server 3. This processing will be described later in detail with reference to a variation.

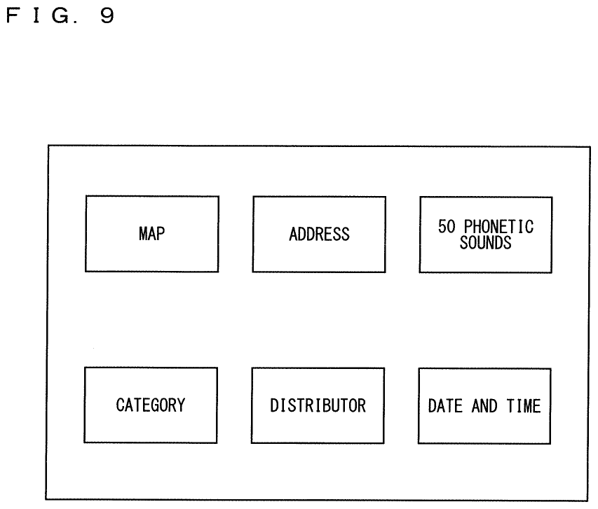

FIG. 9 shows an example of display on the trip-participation communication terminal 46 during the trip permission processing in step S22.

In the example illustrated in FIG. 9, a search menu that includes map, address, 50 phonetic sounds, category (e.g., facility, sight-seeing place, mountain, sea, or night view), distributor (e.g., personal information such as vehicle type, age, and sex), and driving date and time is displayed, like a search menu of a car navigation device that offers destinations. The distribution mediation server 3 selects trip invitation conditions that are to be transmitted to the trip-participation communication terminal 46, based on a search tree using the search menu illustrated in FIG. 6 as an entrance. This enables the user to search for trip invitation conditions desired by the user step by step, using the menu in FIG. 9 as an entrance.

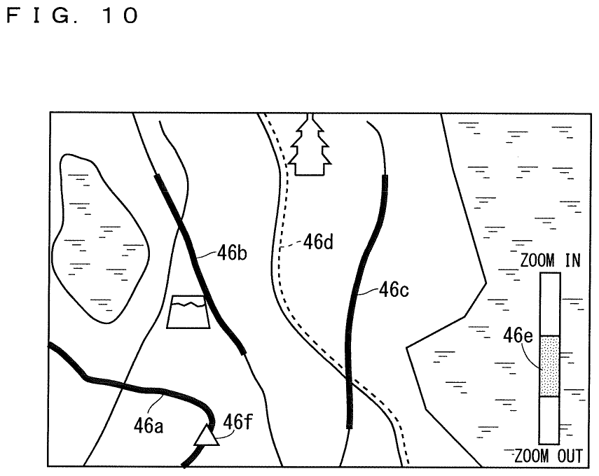

FIG. 10 shows an example of display on the trip-participation communication terminal 46 when MAP is selected from the menu in FIG. 9.

In FIG. 10, set paths 46a to 46d included in a plurality of entered trip invitation conditions are displayed in bold or dotted lines. The user of the trip-participation communication terminal 46 selects, from among the set paths 46a to 46d, a set path along which the user wants to receive the distribution of the running-state information. On the right side in FIG. 10, a slide switch 46e is provided to allow selective zooming in or out of a map. Using the slide switch 46e, the user selectively zooms in and out the map. This enables the user to easily check whether there is an entry of a set path in the area from which the user wants to receive the distribution.

Note that the trip-participation communication terminal 46 may change a mode of display of each set path based on the set date and time. For example, as illustrated in FIG. 10, the trip-participation communication terminal 46 may display the set paths 46a to 46c whose set date and time are either today or tomorrow in bold lines, and may display the set path 46d whose set date and time are two to seven days after in dotted lines. Moreover, the set path 46a on which the running-state distribution vehicle 42 is already running at the current time may be displayed with a vehicle mark 46f that indicates the position of the running-state distribution vehicle 42.

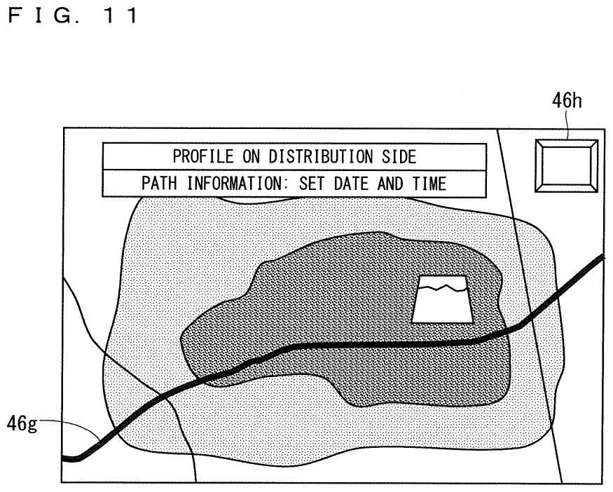

FIG. 11 shows an example of display on the trip-participation communication terminal 46 when a trip invitation condition is selected as a result of the user selecting a set path. In FIG. 11, a profile on the distribution side and an entire set path 46g selected by the user are displayed. For example, the profile on the distribution side may include information such as the set date and time, the name of the set path, and the access method of distributing the running-state information.

The trip-participation communication terminal 46 may permit the distribution of the running-state information on the whole set path 46g in response to a user operation, or may permit the distribution of the running-state information on one or multiple portions of the set path 46g in response to a user operation. The one or multiple portions of the set path 46g may be set by the user performing an operation of specifying leading and trailing edges of each portion after the operation of a trimming button 46h.

In step S23 in FIG. 8, the trip arbitrator 34 determines whether or not the communicator 31 has received permission to distribute the running-state information under the trip invitation condition from the candidate for the distribution destination such as the trip-participation communication terminal 46. For example, the trip arbitrator 34 may determine whether the candidate for the distribution destination such as the trip-participation communication terminal 46 has accepted an operation or the like of permitting the distribution of the running-state information from user, so as to determine whether the permission for distribution to conclude a distribution contract has been received from the candidate for the distribution destination. When the communicator 31 is determined to have received the permission for distribution from the candidate for the distribution destination, the processing proceeds to step S24, and when the communicator 31 is determined not to have received the permission for distribution from the candidate for the distribution destination, the processing returns to step S21.

In step S24, the trip arbitrator 34 transmits the distribution-destination establishment information to the distribution source such as the running-state distribution vehicle 42. For example, the distribution-destination establishment information may include information indicating that the contract to permit distribution (i.e., application for trip participation) is concluded, and an access method of making access to the candidate for the distribution destination serving as the distribution destination.

In step S25, the trip arbitrator 34 transmits information indicating that the application for trip participation has been accepted and the access method of making access to the distribution source, to the distribution destination such as the trip-participation communication terminal 46. Then, the running-state distribution vehicle 42 performs operations similar to those of the distribution control device 1 and the vehicle 21 described in Embodiment 1, so that the distribution source distributes the running-state information to the distribution destination.

That is, the running-state distribution vehicle 42 stores those of the trip invitation conditions under which the candidate for the distribution destination has permitted the distribution of the running-state information, in a storage similar to the offered-condition storage 15 in FIG. 1. Then, the running-state distribution vehicle 42, which has been determined to be positioned within the path range corresponding to the set path included in the trip invitation conditions, distributes the running-state information to the distribution destination such as the live-information reproducer 47. This enables the client to obtain a virtual feeling of riding and driving in the running-state distribution vehicle 42. After step S25, the processing returns to step S21.

Summary of Embodiment 2

The distribution mediation server 3 according to Embodiment 2 of the present embodiment transmits the distribution-destination establishment information for allowing the distribution source to set the candidate for the distribution destination as the distribution destination, when receiving permission to distribute the running-state information on the set path preset by the distribution source from the candidate for the distribution destination. With this configuration, the set path preset by the distribution source is used as a path on which the running-state information is distributed. Accordingly, it is possible to increase the possibility that the distribution destination such as the client is able to receive the running-state information from the distribution source.

Variation 1 of Embodiment 2

In Embodiment 2, the distribution source may make access to the distribution destination so as to establish communication between the distribution source and the distribution destination as in Embodiment 1, or the distribution destination may make access to the distribution source to establish communication between the distribution source and the distribution destination as in Variation 1 of Embodiment 1. Moreover, for example, at the set date and time, the distribution destination may make access to the distribution source, or may perform part of the processing of the distribution mediation server 3.

Variation 2 of Embodiment 2

Although, in Embodiments 1 and 2, the distribution source directly distributes the running-state information to the distribution destination, the present disclosure is not limited to these examples. For example, the distribution source may distribute the running-state information via the distribution mediation server 3 to the distribution destination.

The trip arbitrator 34 of the distribution mediation server 3 may perform part of the processing for distributing the running-state information from the distribution source to the distribution destination. For example, the trip arbitrator 34 may perform trigger control or the like to distribute the running-state information to the distribution destination, on the basis of whether the running-state distribution vehicle 42 is positioned within the path range.

Moreover, the trip arbitrator 34 may transmit the position of the running-state distribution vehicle 42 to the distribution destination, or may put an access point from the distribution source and an access point at the distribution destination on a homepage and a membership site in order to distribute the running-state information.

Variation 3 of Embodiment 2

The trip arbitrator 34 may determine, on the basis of traffic information and the position of the running-state distribution vehicle 42 received by the communicator 31, whether a predicted start time at which the running-state distribution vehicle 42 is predicted to start to run on the set path is before or after the set date and time. Then, when the predicted start time is determined to be before or after the set date and time, the trip arbitrator 34 may transmit in advance the predicted start time and information indicating that the distribution will start before or after the set date and time, to the candidate for the distribution destination or the distribution destination. The trip arbitrator 34 may also transmit in advance information obtained by checking the distribution source for the reason of delay or the like, to the candidate for the distribution destination or the distribution destination. Moreover, if the distribution from the distribution source is determined to be disapproved based on information received from the distribution source, the trip arbitrator 34 may transmit this fact in advance to the candidate for the distribution destination or the distribution destination. Note that the communication such as checking described above may be established directly between the distribution source and the candidate for the distribution destination or the distribution destination without the intervention of the distribution mediation server 3.

The trip invitation conditions may include a first trip invitation condition that is a first invitation condition, and a second trip invitation condition that is a second invitation condition. In the case where the distribution source has changed the first trip invitation condition, the trip arbitrator 34 may transmit a second trip invitation condition that is similar to the first trip invitation conditions before the change, to the candidate for the distribution destination or the distribution destination as an alternative to the first trip invitation condition before the change.

Variation 4 of Embodiment 2

The trip-invitation-condition storage 33 may enter, as a trip invitation condition, an invitation condition under which the running-state information on the driving of the running-state distribution vehicle 42 has already been distributed, and offer the trip invitation condition to the distribution destination.

When transmitting and offering the trip invitation condition to the candidate for the distribution destination, the trip arbitrator 34 may further transmit information indicating whether or not the running-state information has already been distributed, to the candidate for the distribution destination. Then, the candidate for the distribution destination such as the trip-participation communication terminal 46 may display, to the user, information indicating whether or not the running-state distribution vehicle 42 is already running on the set path by means of the vehicle mark 46f or a list of icons of the vehicle mark 46f as illustrated in FIG. 10 in the trip permission processing performed in step S22 in FIG. 8.

When transmitting and offering the trip invitation condition to the candidate for the distribution destination, the trip arbitrator 34 may further transmit, to the candidate for the distribution destination, information about landscapes along the set path for which the running-state information has already been distributed. Then, the candidate for the distribution destination such as the trip-participation communication terminal 46 may display the information about landscapes to the user by means of a balloon mark or the like in the trip permission processing performed in step S22 in FIG. 8. Examples of the information about landscapes include “we can see a rainbow,” “fireworks are beautiful,” and “It's nice.”

Variation 5 of Embodiment 2

The trip arbitrator 34 may receive a condition request for an invitation condition from the candidate for the distribution destination. The condition request includes, for example, a request for the set path and a request for the set date and time. Examples of the request for the set path include a request for the set path to pass through POI such as a sight-seeing place and a request for the set path to pass through at least one of a coast, a forest, Mount Fuji, or a place at a high elevation. A combination of the request for the set path and the request for the set date and time may include, for example, a combination of the path and the date and time on and at which a natural phenomenon occurs, such as “we want to see the sunrise, “we want to see a solar eclipse,” or “we want to see a meteor.”

When the communicator 31 has received a condition request from the candidate for the distribution destination, the trip arbitrator 34 may cause the communicator 31 to transmit information on the invitation condition corresponding to the condition request to the candidate for the distribution destination. The invitation condition as used herein includes a trip invitation condition. The case where the invitation condition corresponds to the condition request includes the case where the invitation condition matches or nearly matches with the condition request. The communicator 31 may receive the invitation condition either before or after the communicator 31 receives the condition request. Information about the invitation condition may be the invitation condition itself, or may be information indicating the entry of the invitation condition.

For example, in the case where the trip-invitation-condition storage 33 stores a trip invitation condition that matches with a condition request when the condition request has been received, the trip arbitrator 34 may transmit and offer the stored trip invitation condition to the candidate for the distribution destination.

For example, in the case where the trip-invitation-condition storage 33 stores a trip invitation condition that nearly matches with a condition request when the condition request has been received, the trip arbitrator 34 may transmit and offer the stored trip invitation condition to the candidate for the distribution destination. The trip invitation condition that nearly matches with the condition request as used herein refers to the trip invitation condition whose difference from the condition request is less than or equal to a threshold value. In the case where the trip-invitation-condition storage 33 stores a plurality of trip invitation conditions that nearly matches with the condition request, the trip arbitrator 34 may transmit and offer these trip invitation conditions to the candidate for the distribution destination in the order of similarity to the condition request (i.e., in ascending order of the difference from the condition request).

For example, in the case where the trip-invitation-condition storage 33 does not store any trip invitation condition that corresponds to a condition request when the condition request has been received, but a trip invitation condition that corresponds to the condition request is entered at a later date, information indicating that the corresponding trip invitation condition has been entered may be transmitted to the candidate for the distribution destination.

Variation 6 of Embodiment 2

In the case where the communicator 31 has received a condition request for an invitation condition from the candidate for the distribution destination, the trip arbitrator 34 may cause the communicator 31 to transmit information about the condition request to the distribution source. The condition request is the same as that described in Variation 6 of Embodiment 2. The information about the condition request may be the condition request itself, may be a list of condition requests, or may be correction that is made to an invitation condition that nearly matches with the condition request.

For example, in the case where the trip-invitation-condition storage 33 does not store a trip invitation condition that corresponds to a condition request when the condition request has been received from the candidate for the distribution destination, the trip arbitrator 34 may transmit and offer a list of condition requests with appropriate timing to the distribution source. Then, the trip arbitrator 34 may perform processing for receiving an invitation condition that is corrected based on the condition request from the distribution source and getting agreement between the distribution source and the distribution destination.

For example, in the invitation-condition acceptance processing performed in step S12 in FIG. 6, the trip arbitrator 34 may determine whether or not the invitation condition received from the distribution source nearly matches with the condition request received from the distribution destination, e.g., whether or not the set path included in the invitation condition nearly matches with the path included in the condition request. Then, if the invitation condition is determined to nearly match with the condition request, the trip arbitrator 34 may transmit the presence of the condition request and the candidate for the distribution destination to the distribution source and sound out the distribution source on the correction of the invitation condition.

### Embodiment 3

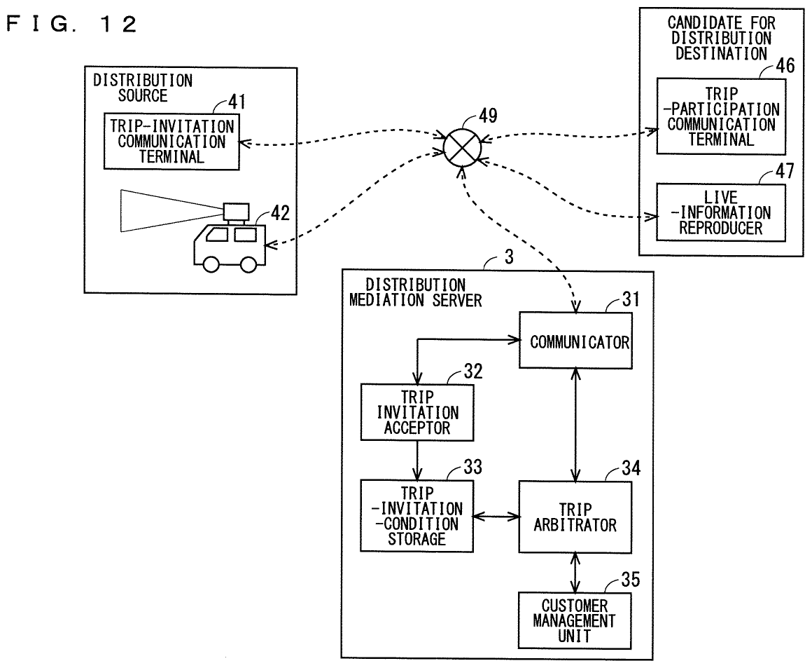

FIG. 12 is a block diagram illustrating a configuration of a distribution mediation server 3 according to Embodiment 3 of the present disclosure. Hereinafter, among constituent elements according to Embodiment 3 of the present disclosure, those that are the same as or similar to those described above are given the same or similar reference signs, and different constituent elements are mainly described below.

The configuration of the distribution mediation server 3 in FIG. 12 is similar to a configuration obtained by adding a customer management unit 35 to the distribution mediation server 3 illustrated in FIG. 5. The customer management unit 35 registers, stores, and manages information on a distribution source and a candidate for a distribution destination as customer information. The customer management unit 35 is included in the concept of the storage. The information on the distribution source, included in the customer information, may include, for example, address, name, and age of the distribution source (i.e., distributor), vehicle type, authentication information, an access method, and past records and reputation. The information on the candidate for the distribution destination, included in the customer information, is approximately the same as the information on the distribution source, included in the customer information. The customer information is not limited to both of the information on the distribution source and the information on the candidate for the distribution destination, but may be either one of the information on the distribution source and the information on the candidate for the distribution destination.

The trip arbitrator 34 calculates the reliability of a distribution contract for the distribution source, based on the customer information on the distribution source in the customer management unit 35. For example, if the distribution source is involved in a large number of changes and deletions of trip invitation conditions and a large number of deviations from the set path during the distribution period, the trip arbitrator 34 may lower the reliability of the distribution contract for the distribution source.

The trip arbitrator 34 also calculates the reliability of a distribution contract for the candidate for the distribution destination, based on the customer information on the candidate for the distribution destination in the customer management unit 35. For example, if the candidate for the distribution destination is involved in a fixed number or more of claims and cancels and a large number of delays in payment, the trip arbitrator 34 may lower the reliability of the distribution contract for the candidate for the distribution destination.

Operations

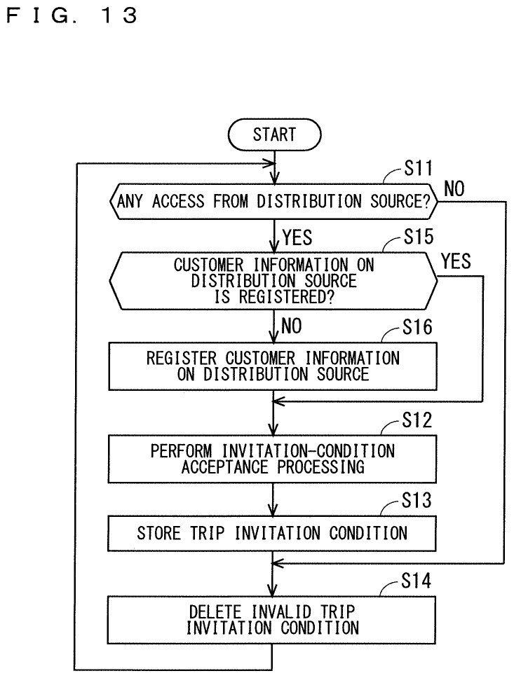

FIG. 13 is a flowchart illustrating the condition receiving operation of the distribution mediation server 3 according to Embodiment 3 of the present disclosure. The operation in FIG. 13 is similar to an operation obtained by adding steps S15 and S16 to the operation illustrated in FIG. 6. The following description is mainly given of operations performed in steps S15 and S16.

Afar the processing in step S11, in step S15, the trip arbitrator 34 determines whether or not the customer information on the distribution source is registered in the customer management unit 35. When the customer information on the distribution source is determined to be registered in the customer management unit 35, the processing proceeds to step S12, and when the customer information on the distribution source is determined not to be registered in the customer management unit 35, the processing proceeds to step S16.

In step S16, the trip arbitrator 34 registers the customer information on the distribution source in the customer management unit 35 according to a predetermined format. At this time, the trip arbitrator 34 calculates the reliability of the distribution contract for the distribution source based on the customer information on the distribution source, adds this reliability to the customer information, and registers the customer information in the customer management unit 35. Thereafter, the processing proceeds to step S12.

In step S12, the trip invitation acceptor 32 performs invitation-condition acceptance processing for accepting invitation conditions as illustrated in FIG. 7. In step S13, the trip invitation acceptor 32 stores the accepted invitation conditions in the trip-invitation-condition storage 33. In Embodiment 3 of the present disclosure, since at least some of the invitation conditions in FIG. 7 are registered as the customer information, it is possible to simplify the processing in step S12 and the processing in step S13. In the case where the reliability of the distribution contract for the distribution source is less than or equal to a threshold value, the trip invitation acceptor 32 may refuse the entry of invitation conditions from the distribution source. The trip invitation acceptor 32 may transmit and offer this reliability to the candidate for the distribution destination when transmitting and offering trip invitation conditions to the candidate for the distribution destination.

In step S14, the trip arbitrator 34 deletes invalid trip invitation conditions from the trip-invitation-condition storage 33. For example, the trip arbitrator 34 may delete trip invitation conditions whose set date and time have passed and the current date and time is later by a threshold value or more from the set date and time and trip invitation conditions whose reliability of the distribution contract for the distribution source is less than or equal to the threshold value from the trip-invitation-condition storage 33. After step S14, the processing returns to step S11.

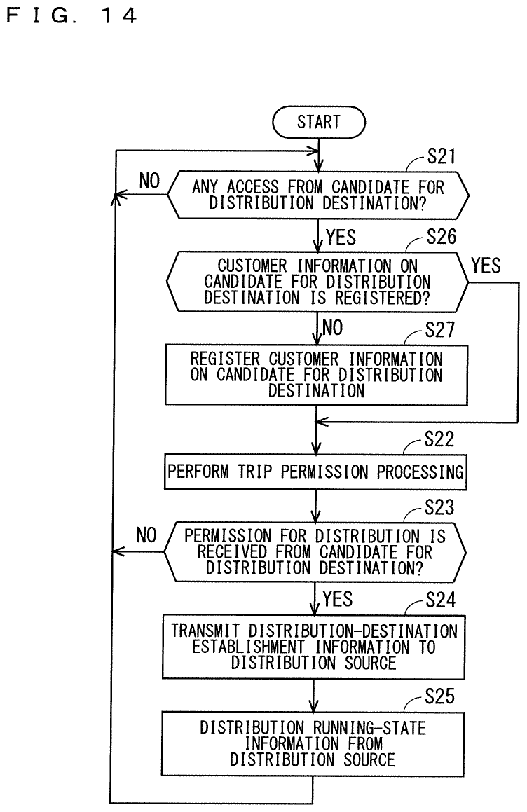

FIG. 14 is a flowchart mainly illustrating the permission receiving operation of the distribution mediation server 3 according to Embodiment 3 of the present disclosure. The operation in FIG. 14 is similar to an operation obtained by adding steps S26 and S27 to the operation illustrated in FIG. 8. The following description is mainly given of operations performed in steps S26 and S27.

After the processing in step S21, in step S26, the trip arbitrator 34 determines whether or not the customer information on the candidate for the distribution destination is registered in the customer management unit 35. When the customer information on the candidate for the distribution destination is determined to be registered in the customer management unit 35, the processing proceeds to step S22, and when the customer information on the candidate for the distribution destination is determined not to be registered in the customer management unit 35, the processing proceeds to step S27.

In step S27, the trip arbitrator 34 registers the customer information on the candidate for the distribution destination in the customer management unit 35 according to a predetermined format. At this time, the trip arbitrator 34 calculates the reliability of the distribution contract for the candidate for the distribution destination based on the customer information on the candidate for the distribution destination, adds this reliability to the customer information, and registers the customer information in the customer management unit 35. Thereafter, the processing proceeds to step S22.

In step S22, the trip arbitrator 34 performs trip permission processing. In the case where the reliability of the distribution contract for the candidate for the distribution destination is less than or equal to a threshold value, the trip arbitrator 34 may refuse permission from the candidate for the distribution destination. Thereafter, the processing from step S23 onward is performed.

Summary of Embodiment 3

The distribution mediation server 3 according to Embodiment 3 calculates the reliability of the distribution contract for the distribution source and the reliability of the distribution contract for the candidate for the distribution destination based on the customer information on the distribution source and the customer information on the candidate for the distribution destination that are registered in the customer management unit 35. This configuration improves the efficiency of the distribution contracts.

### Embodiment 4

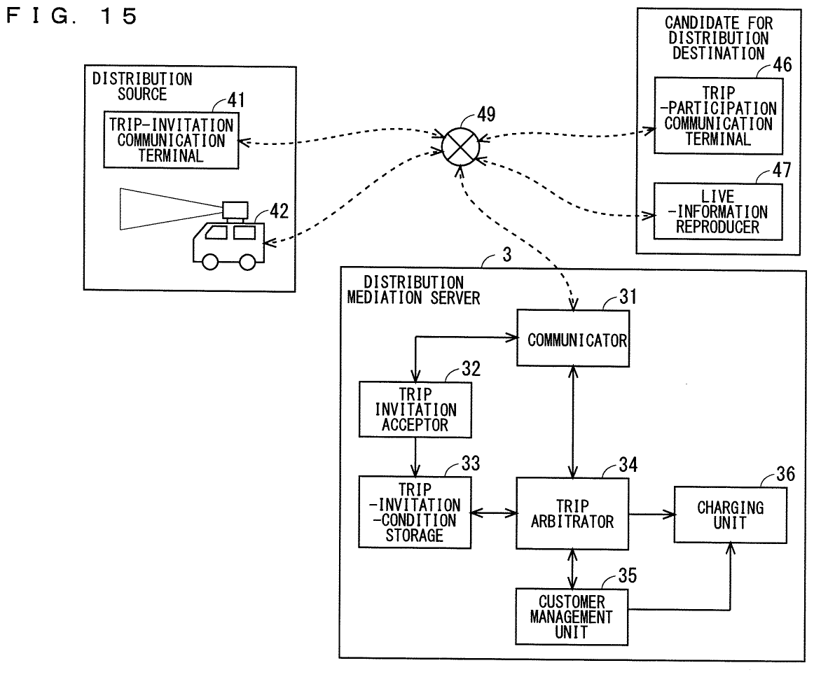

FIG. 15 is a block diagram illustrating a configuration of a distribution mediation server 3 according to Embodiment 4 of the preset disclosure. Hereinafter, among constituent elements according to Embodiment 4 of the present disclosure, those that are the same as or similar to those described above are given the same or similar reference signs, and different constituent elements are mainly described below.

The configuration of the distribution mediation server 3 illustrated in FIG. 15 is similar to a configuration obtained by adding a charging unit 36 to the distribution mediation server 3 illustrated in FIG. 12. Note that the charging unit 36 may be added to the distribution mediation server 3 illustrated in FIG. 5.

The charging unit 36 calculates a compensation to be paid to the distribution source and a compensation to be charged to the candidate for the distribution destination based on charging conditions that include a set path for which the running-state information is to be distributed and the type of the running-state information. Note that the charging unit 36 may increase the compensation as the distance of the set path increases. The charging unit 36 may also increase the compensation as the resolution of the video information included in the running-state information increases or as the number of types of the running-state information increases. The charging conditions may further include the model type of the running-state distribution vehicle 42.

The charging unit 36 may calculate a compensation before the trip invitation conditions are offered in step S22 in FIG. 8, or may offer the calculated compensation together with the trip invitation conditions. The charging unit 36 may also calculate a compensation when the distribution of the running-state information is completed. The charging unit 36 may make access to the accounts of banking facilities or virtual currency (also referred to as electronic cash or cipher currency) of the distribution source and the distribution destination and may pay the compensation to the distribution source and charge the compensation to the distribution destination. The account of the banking facility or virtual currency of the distribution source may be set, for example, when the processing for registering the customer information on the distribution source is performed in step S16 in FIG. 13. The account of the banking facility or virtual currency of the candidate for the distribution destination may be set, for example, when the processing for registering the customer information on the candidate for the distribution destination is performed in step S27 in FIG. 14. Note that the compensations are not limited to cash and may, for example, be service points, coupons, or items.

Summary of Embodiment 4

The distribution mediation server 3 according to Embodiment 4 calculates a compensation to be paid to the distribution source and a compensation to be charged to the candidate for the distribution destination based on charging conditions that include the set path on which the running-state information is distributed and the type of the running-state information. This configuration improves the efficiency of distribution contracts.

Variation 1 of Embodiment 4

The charging conditions may further include a request received from the distribution destination, the request being executed by the side of the running-state distribution vehicle 42 during the distribution period in which the running-state information is distributed. For example, the charging unit 36 may increase the compensation as the load of the request executed by the side of the running-state distribution vehicle 42 and received from the distribution destination increases. Note that the request executed by the side of the running-state distribution vehicle 42 and received from the distribution destination may, for example, be the same as the request made from the distribution destination toward the vehicle 21, described in Variation 5 of Embodiment 1.

Variation 2 of Embodiment 4

The charging conditions may further include at least one of weather around the running-state distribution vehicle 42, difficulty in running on the set path, or a fee charged to run on the set path. The charging unit 36 may increase the compensation, for example, when the weather around the running-state distribution vehicle 42 is heavy snow. The charging unit 36 may also increase the compensation, for example, when the set path is a mountain-road path or an off-road path. The charging unit 36 may also increase the compensation, for example, when a roll is charged to drive on the set path or when more than an ordinary fuel cost is necessary.

Variation 3 of Embodiment 4

The charging conditions may further include the reliability of a distribution contract for at least either one of the distribution source and the candidate for the distribution destination described in Embodiment 3. For example, in the case where the reliability of the distribution contract for the distribution source is lowered due to a fixed number or more of deletions of trip invitation conditions by the distribution source, the charging unit 36 may lower the compensation to be paid to the distribution source in consideration of a penalty. For example, in the case where the reliability of the distribution contract for the candidate for the distribution destination is lowered due to a fixed number or more of cancels by the candidate for the distribution destination, the charging unit 36 may increase the compensation to be charged to the candidate for the distribution destination in consideration of a penalty.

Variation 4 of Embodiment 4

The running-state distribution vehicle 42 may be a customer's pick-up vehicle that drives under an invitation condition, i.e., the set path and the set date and time. In the case where the running-state distribution vehicle 42 is a customer's pick-up vehicle, clients may be limited to all who are parties to passengers who are sent off by the customer's pickup vehicle and passengers who request a pick-up, such as user members of the pick-up service. Examples of the pick-up service include a send-off to day-care service facilities and a send-off of children. The pick-up service may include a distribution service for distributing the running-state information as a package.

Alternatively, the running-state distribution vehicle 42 may be a public transportation vehicle or a freight transportation vehicle that drives under an invitation condition, i.e., the set path and at the set date and time. The public transportation vehicle or the freight transportation vehicle may, for example, be public transportation such as a bus or a business-use vehicle such as a delivery truck.

Note that the charging conditions may further include information indicating whether the running-state distribution vehicle 42 is a customer's pickup vehicle, a public transportation vehicle, or a freight transportation vehicle. Variation 4 of the present disclosure may be applied to the vehicle 21 according to Embodiment 1, and may also be applied to the running-state distribution vehicle 42 according to Embodiments 2 and 3.

Variation 5 of Embodiment 4

Embodiment 2 has described, with reference to FIG. 11, a case in which the candidate for the distribution destination permits the distribution of the running-state information about one or multiple portions of the set path. The charging conditions may further include information indicating whether or not the candidate for the distribution destination has permitted the distribution of the running-state information about part of the set path. For example, the charging unit 36 may make the compensation for the distribution of the running-state information about part of the set path lower than the compensation for the distribution of the running-state information about the whole of the set path.

Other Variations

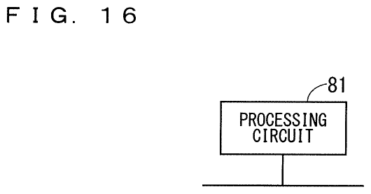

The acquisition unit and the controller in the distribution control device described above are hereinafter referred to as the “acquisition unit and the like.” The acquisition unit and the like are implemented as a processing circuit 81 illustrated in FIG. 16. That is, the processing circuit 81 includes an acquisition unit that acquires the position of a vehicle included in the distribution source and running-state information including video information on the periphery of the vehicle, and the controller that performs control such that the running-state information is distributed from the distribution source to the distribution destination that has permitted the distribution of the running-state information in advance when it is determined on the basis of the position of the vehicle and a set path that is preset by the distribution source that the vehicle is positioned within a range corresponding to the set path. The processing circuit 81 may adopt dedicated hardware, or may adopt a processor that executes programs stored in a memory. Examples of the processor include a central processing unit, a processing device, an arithmetic-logic device, a microprocessor, a microcomputer, and a digital signal processor (DSP).

In the case where the processing circuit 81 is implemented as dedicated hardware, the processing circuit 81 may correspond to, for example, a single circuit, a composite circuit, a programmed processor, a parallel-programmed processor, an application specific integrated circuit (ASIC), or a field programmable gate array (FPGA), or any combination of them. The function of each of the acquisition unit and the like may be implemented as a circuit configured by distributing processing circuits, or may be collectively implemented as a single processing circuit.

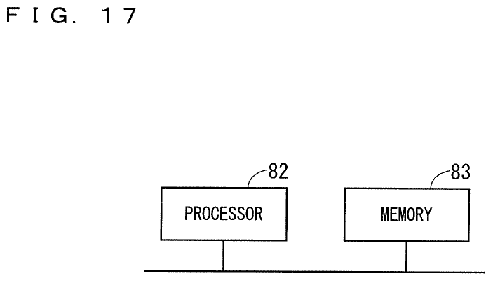

In the case where the processing circuit 81 is implemented as a processor, the functions of the acquisition unit and the like may be implemented as a combination of software and the like. Note that the software and the like may correspond to, for example, software, firmware, or a combination of software and firmware. The software and the like are described as programs and stored in the memory. As illustrated in FIG. 17, the processor 82 applied to the processing circuit 81 achieves the function of each constituent element by reading out and executing programs stored in the memory 83. That is, when implemented as the processing circuit 81, the distribution control device includes a memory 83 for storing programs that causes the following steps to be executed ultimately: the step of acquiring the position of a vehicle included in a distribution source and running-state information that includes video information on the periphery of the vehicle, and the step of performing control so as to distribute the running-state information from the distribution source to the distribution destination that has permitted in advance the distribution of the running-state information, when the vehicle is determined to be positioned within the range corresponding to the set path on the basis of the position of the vehicle and the set path that is preset in advance by the distribution source. In other words, it can also be said that the program causes a computer to execute the procedure or method used in the acquisition unit and the like. Examples of the memory 83 as used herein include nonvolatile or volatile semiconductor memories such as a random access memory (RAM), a read only memory (ROM), a flash memory, an erasable programmable read only memory (EPROM), and an electrically erasable programmable read only memory (EEPROM), or a drive unit and the like for driving the above memory, such as a hard disk drive (HDD), a magnetic disk, a flexible disk, an optical disk, a compact disk, a minidisk, a digital versatile disc (DVD), and drive devices and the like for driving such a disk, and any other recording medium that may be used in the future.

The above description has been given thus far of a configuration in which each function of the acquisition unit and the like is achieved by any of hardware, software, and the like. However, the present disclosure is not intended to be limited to the examples described above, and a configuration is also possible in which part of the acquirer and the like is achieved by dedicated hardware, and another part is achieved by software and the like. For example, the function of the acquisition unit may be achieved by, for example, the processing circuit 81, an interface, a receiver, and the like that serve as dedicated hardware, and the functions of the other constituent elements may be achieved by the processing circuit 81 serving as the processor 82 to read out and execute programs stored in the memory 83.

As described above, the processing circuit 81 is capable of achieving the functions described above by hardware, software and the like, or any combination of them.

The distribution control device described above may also be applied to a distribution control system that is constructed as a system by appropriately combining, for example, a server, a vehicle device such as a portable navigation device (PND), a navigation device, a driver monitoring system (DMS), or a drive recorder, a communication terminal including a mobile terminal such as a mobile phone, a smartphone, or a tablet, and the functions of applications installed in at least either of the vehicle device and the communication terminal. In this case, each function or each constituent element of the distribution control device described above may be distributed and arranged in each equipment that constructs the system, or may be centrally arranged in any of the equipment.

Although the hardware configuration of the distribution control device 1 according to Embodiment 1 has been described thus far, the same described above applies to the hardware configuration of the distribution mediation server 3 according to Embodiments 2 to 4.

It should be noted that the present disclosure can be implemented by freely combining the above embodiments or by making a modification or omission to the embodiments as appropriate without departing from the scope of the present disclosure.

While the invention has been shown and described in detail, the foregoing description is in all aspects illustrative and not restrictive. It is therefore to be understood that numerous modifications and variations can be devised without departing from the scope of the invention.

### EXPLANATION OF REFERENCE SIGNS

1 distribution control device
3 distribution mediation server
12 positioner
13 running-state acquisition unit
17 controller
21 vehicle
22 communication device
31 communicator
33 trip-invitation-condition storage
34 trip arbitrator
42 running-state distribution vehicle

1. A distribution control apparatus comprising:
an acquisition circuitry that acquires a position of a vehicle included in a distribution source and running-state information that includes video information on a periphery of the vehicle; and
a controller that offers a set path that is preset by the distribution source to a candidate for the distribution destination and performs control to distribute the running-state information from the distribution source to the distribution destination being the candidate for the distribution destination that has permitted the distribution of the running-state information regarding the set path, when the vehicle is determined to be positioned within a range corresponding to the set path, based on the position of the vehicle and the set path.

2. The distribution control apparatus according to claim 1, wherein
the running-state information further includes detection information detected by the vehicle.

3. The distribution control apparatus according to claim 1, wherein
the running-state information further includes audio information on the periphery of the vehicle, and
the video information and the audio information are capable of three-dimensional reproduction.

4. The distribution control apparatus according to claim 1, wherein
the running-state information further includes at least one of running sensor information displayed on a meter panel of the vehicle, vehicle sensor information used to control driving of the vehicle, or weather information on weather around the vehicle.

5. The distribution control apparatus according to claim 1, wherein
the running-state information further includes at least one of physiological information, mental information, or posture information that are information on a driver of the vehicle.

6. The distribution control apparatus according to claim 1, wherein
the distribution control apparatus stores a request that is sent from the distribution destination and executed by the vehicle when running on the set path.

7. (canceled)

8. (canceled)

9. (canceled)

10. The distribution control apparatus according to claim 1, wherein
the distribution control apparatus is provided in a drive recorder of the vehicle.

11. A distribution mediation server that mediates a distribution contract between a distribution source and a candidate for a distribution destination on distribution of running-state information received from a vehicle included in the distribution source, the distribution mediation server comprising:
a communicator that communicates with the distribution source and the candidate for the distribution destination;
a storage that stores an invitation condition when the communicator receives the invitation condition from the distribution source, the invitation condition including a set path and a set date and time that are preset by the distribution source; and
a controller that performs control to transmit the invitation condition that is stored, from the communicator to the candidate for the distribution destination when the candidate for the distribution destination makes access to the communicator, and performs control to transmit distribution-destination establishment information from the communicator to the distribution source when the communicator receives permission to distribute the running-state information from the candidate for the distribution destination, the distribution-destination establishment information being information for the distribution source to establish the candidate for the distribution destination as a distribution destination of distribution of the running-state information.

12. The distribution mediation server according to claim 11, wherein
the controller performs part of distribution processing for distributing the running-state information from the distribution source to the distribution destination.

13. (canceled)

14. The distribution mediation server according to claim 11, wherein
when performing control to transmit the invitation condition from the communicator to the candidate for the distribution destination, the controller further performs control to transmit information that indicates whether or not the running-state information has already been distributed.

15. The distribution mediation server according to claim 11, wherein
when performing control to transmit the invitation condition from the communicator to the candidate for the distribution destination, the controller further performs control to transmit information on a landscape along the set path for which the running-state information has already been distributed.

16. The distribution mediation server according to claim 11, wherein
when the communicator receives a condition request for the invitation condition from the candidate for the distribution destination, the controller performs control to transmit information that indicates the invitation condition corresponding to the condition request from the communicator to the candidate for the distribution destination.

17. The distribution mediation server according to claim 11, wherein
when the communicator receives a condition request for the invitation condition from the candidate for the distribution destination, the controller performs control to transmit information on the condition request from the communicator to the distribution source.

18. The distribution mediation server according to claim 11, wherein
the storage stores information on at least one of the distribution source or the candidate for the distribution destination as customer information, and
the controller calculates reliability of the distribution contract for the at least one based on the customer information.

19. The distribution mediation server according to claim 11, further comprising:
a charging circuitry that calculates a compensation to be paid to the distribution source and a compensation to be charged to the candidate for the distribution destination based on a charging condition that includes a type of the running-state information and the set path for which the running-state information is distributed.

20. The distribution mediation server according to claim 19, wherein
the charging condition further includes a request that is sent from the distribution destination and executed by the vehicle during a distribution period in which the running-state information is distributed.

21. (canceled)

22. The distribution mediation server according to claim 19, wherein
the storage stores information on at least one of the distribution source or the candidate for the distribution destination as customer information,
the controller calculates reliability of the distribution contract for the at least one based on the customer information, and
the charging condition further includes the reliability.

23. The distribution mediation server according to claim 11, wherein
the vehicle includes a customer's pick-up vehicle that runs under the invitation condition.

24. The distribution mediation server according to claim 11, wherein
the vehicle includes a public transportation vehicle or a freight transportation vehicle that runs under the invitation condition.

25. (canceled)

26. A distribution mediation method for mediating a distribution contract between a distribution source and a candidate for a distribution destination on distribution of running-state information received from a vehicle included in the distribution source, the distribution mediation method comprising:
communicating with the distribution source and the candidate for the distribution destination by a communicator;
storing an invitation condition when the communicator receives the invitation condition from the distribution source, the invitation condition including a set path and a set date and time that are preset by the distribution source; and
performing control to transmit the invitation condition that is stored, from the communicator to the candidate for the distribution destination when the candidate for the distribution destination makes access to the communicator, and performing control to transmit distribution-destination establishment information from the communicator to the distribution source when the communicator receives permission to distribute the running-state information from the candidate for the distribution destination, the distribution-destination establishment information being information for the distribution source to establish the candidate for the distribution destination as a distribution destination of distribution of the running-state information.
